(19) United States
(12) Patent Application Publication
(10) Pub. No.: US 2015/0173150 A1
(43) Pub. Date: Jun. 18, 2015

(54) Balanced AC Direct Driver Lighting System with a Valley Fill Circuit and a Light Balancer

(71) Applicant: Altoran Chips & Systems, Santa Clara, CA (US)

(72) Inventors: Minjong Kim, San Jose, CA (US); Weifeng Chen, San Jose, CA (US); Juhwan Jeong, Suwon (KR); Kyeongtae Moon, San Ramon, CA (US); Jae Hong Jeong, Saratoga, CA (US)

(21) Appl. No.: 14/566,710

(22) Filed: Dec. 11, 2014

Related U.S. Application Data
(60) Provisional application No. 61/917,332, filed on Dec. 17, 2013.

(51) Int. Cl. H05B 33/08

(52) U.S. Cl. CPC H05B 33/0851

(57) ABSTRACT

An AC direct driver lighting system is disclosed. According to one embodiment, the AC direct driver lighting system includes an AC power source, a plurality of LED groups, and an AC driver comprising a current sink connected between the AC power source and the plurality of LED groups. The AC direct driver lighting system further includes at least one of a valley fill circuit and a load balancer circuit coupled to a target LED group of the plurality of LED groups. The valley fill circuit charges supplies electrical power to a target LED group and the load balancer circuit reduces the current flowing through the target LED group.

### CROSS REFERENCES

This application claims the benefits of and priority to U.S. Provisional Application No. 61/917,332, filed on Dec. 17, 2013, entitled “Apparatus for Flicker-free, Balanced-Light AC Direct Step Driver Lighting System with Valley Fill and Light Balancer,” the disclosure of which is hereby incorporated by reference in its entirety.

### FIELD

The present disclosure relates in general to the field of AC lighting systems, and in particular, to a balanced AC direct driver lighting system with a valley fill circuit and a light balancer.

### BACKGROUND

An alternating current (AC) lighting system refers to a system that directly drives a lighting load such as light emitting diode (LED), organic light emitting diode (OLED), or other light emitting devices or components using rectified AC line voltage from an AC power source. AC lighting systems eliminate the need of a power conversion unit from an AC power source to a direct current (DC) power source. Due to their simple design and less components, AC lighting systems provide a low-cost solution for residential or commercial applications receiving power directly from an AC power source.

Despite their cost advantages, implementation of advanced features such as dimming control, mood lights, and color variations in a conventional AC lighting system poses technical difficulties because the fluctuating AC line voltage. Furthermore, LED segments in a conventional AC lighting system are often driven in a sequential order, therefore light emitted from each LED segment is not uniform across a light fixture. If the voltage across an LED group of an AC lighting system is not high enough to turn the LEDs within the LED group, the corresponding LED group turns off resulting in an undesirable ripple of the AC lighting system.

### SUMMARY

An AC direct driver lighting system is disclosed. According to one embodiment, the AC direct driver lighting system includes an AC power source, a plurality of LED groups, and an AC driver comprising a current sink connected between the AC power source and the plurality of LED groups. The AC direct driver lighting system further includes at least one of a valley fill circuit and a load balancer circuit coupled to a target LED group of the plurality of LED groups. The valley fill circuit charges supplies electrical power to a target LED group and the load balancer circuit reduces the current flowing through the target LED group.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of the present disclosure.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles described herein.

FIG. 1 illustrates a prior art AC direct step lighting system;

FIG. 2 illustrates a prior art AC direct step lighting system including a valley fill circuit;

FIG. 3 illustrates another prior art AC direct step lighting system including a valley fill circuit;

FIG. 4 illustrates an exemplary AC direct step lighting system including a valley fill circuit, according to one embodiment;

FIG. 5 illustrates an exemplary AC direct step lighting system including a light balancer circuit, according to one embodiment;

FIG. 6 illustrates an exemplary AC direct step lighting system including a valley fill circuit and a light balancer circuit, according to one embodiment;

FIG. 7 illustrates an exemplary AC direct step lighting system including a valley fill circuit, according to another embodiment;

FIG. 8 illustrates an exemplary AC direct step lighting system including a valley fill circuit for each target LED group, according to one embodiment;

FIG. 9 illustrates an exemplary AC direct step lighting system including a valley fill circuit for each target LED group, according to another embodiment;

FIG. 10 illustrates an exemplary AC direct step lighting system including a valley fill circuit for each target LED group, according to another embodiment;

FIG. 11 illustrates an exemplary AC direct step lighting system including a valley fill circuit for each LED group, according to another embodiment;

FIG. 12 illustrates an exemplary AC direct step lighting system including a plurality of load balancer circuits for each LED group, according to one embodiment;

FIG. 13 illustrates an exemplary AC direct step lighting system including a load balancer circuit for a downstream LED group, according to another embodiment;

FIG. 14 illustrates an exemplary AC direct step lighting system including a load balancer circuit for an upstream LED group, according to another embodiment;

FIG. 15 illustrates an exemplary AC direct step lighting system including a plurality of load balancer circuits for each LED group, according to another embodiment;

FIG. 16 illustrates an exemplary AC direct step lighting system including a valley fill circuit and a light balancer circuit, according to one embodiment;

FIGS. 17-23 illustrate an exemplary AC direct step lighting system including various combinations of a valley fill circuit and a light balancer circuit, according to some embodiments;

The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

### DETAILED DESCRIPTION

An AC lighting system with at least one of a valley fill circuit and a load balancer circuit is disclosed. According to one embodiment, the AC direct driver lighting system includes an AC power source, a plurality of LED groups, and an AC driver comprising a current sink connected between the AC power source and the plurality of LED groups. The AC direct driver lighting system further includes at least one of a valley fill circuit and a load balancer circuit coupled to a target LED group of the plurality of LED groups. The valley fill circuit charges supplies electrical power to a target LED group and the load balancer circuit reduces the current flowing through the target LED group.

Each of the features and teachings disclosed herein can be utilized separately or in conjunction with other features and teachings to provide a method for providing an AC light system with a control unit for controlling power of an LED. Representative examples utilizing many of these additional features and teachings, both separately and in combination, are described in further detail with reference to the attached drawings. This detailed description is merely intended to teach a person of skill in the art further details for practicing preferred aspects of the present teachings and is not intended to limit the scope of the claims. Therefore, combinations of features disclosed in the following detailed description may not be necessary to practice the teachings in the broadest sense, and are instead taught merely to describe particularly representative examples of the present teachings.

In the following description, for purposes of explanation only, specific nomenclature is set forth to provide a thorough understanding of the present invention. However, it will be apparent to one skilled in the art that these specific details are not required to practice the present invention.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

The present disclosure describes a system and method for providing uniform lighting distribution using an AC direct step driver. The present system and method has a simple structure with less electric components and achieves a balance in brightness among LED groups contained in the AC lighting system while reducing ripple.

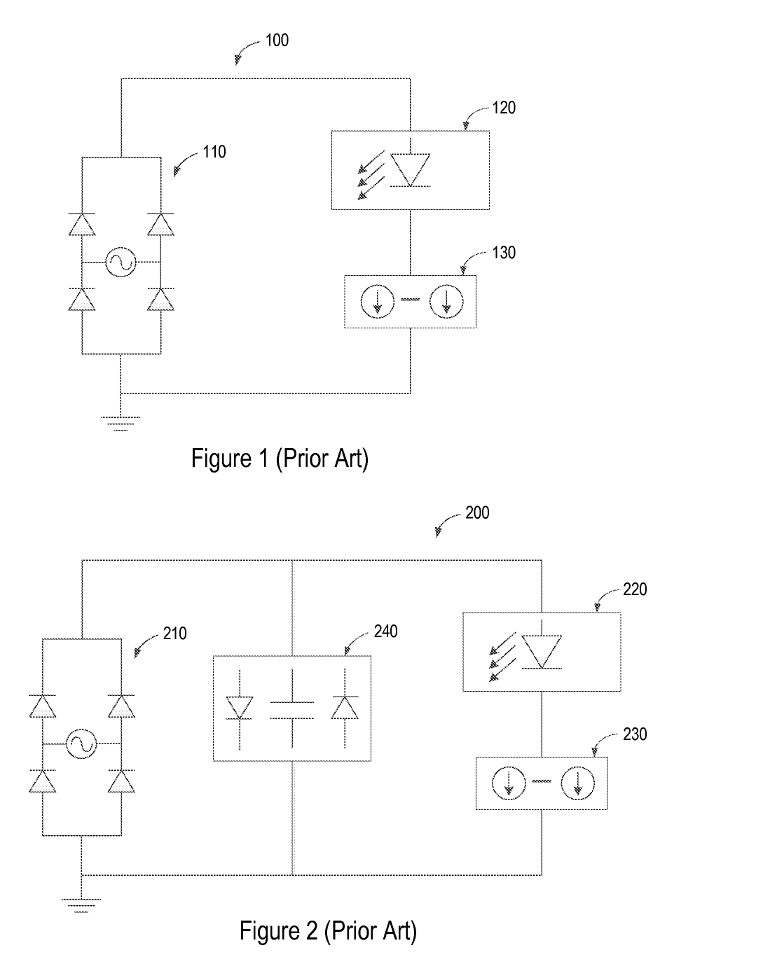

FIG. 1 illustrates a prior art AC direct step lighting system. The AC lighting system 100 includes an LED driver 130 and an LED load 120. The LED driver 130 is powered by a power source 110 such as an alternative current (AC) power source including a fuse and a transient protection circuit between a live wire (AC_L) and a neutral wire (AC_N). The electrical current from the AC power source 110 is rectified by a rectifier circuit. The rectifier circuit can be any suitable rectifier circuit, such as a bridge diode rectifier, capable of rectifying the alternating power from the AC power source 110. The rectified voltage V_{rect} is applied to the LED load 120. If desirable, the AC power source 110 and the rectifier circuit may be replaced by a direct current (DC) power source.

LED as used herein are a general term for many different kinds of LEDs, such as traditional LED, super-bright LED, high brightness LED, organic LED, etc. The LED driver 130 is configured to drive many different kinds of LEDs. The LED load 120 is electrically connected to the power source 110 and is in the form of a string of LEDs divided into a plurality of LED groups. However, it should be apparent to those of ordinary skill in the art that the LED load 120 may contain any number of LED groups and LED elements (or LED dies) in each LED group, and may be divided into any suitable number of groups without deviating from the scope of the present subject matter. The LED elements in each LED group may be a combination of the same or different kind, such as different color. The LED load 120 can be connected in serial, parallel, or a mixture of both. In addition, one or more resistances may be included inside each LED group.

The LED driver 130 controls the LED current that flows through the LED load 120. According to one embodiment, the LED driver 130 is a direct AC step driver ACS0804 or ACS0904 by Altoran Chips and Systems of Santa Clara, Calif. The LED driver 130 integrates a plurality of high voltage current sinks, and each high voltage current sink drives each LED group. When the rectified voltage, V_{rect}, reaches a reference voltage V_{f}, the LED groups in the LED load 120 turn on gradually when the corresponding current sink has a headroom. Each LED channel current sink increases up to a predefined current level for each current sink and maintains its level until the following group's current sink reaches to its headroom. At any point in a time domain, there is at least one active LED group. When the active LED group is changed from one group to the adjacent group with a change in the rectified voltage, V_{rect}, new active group's current gradually increases while the existing active group's current gradually decreases. The mutual compensation between LED groups achieves a smooth LED current change reduces blinking or flickering. However, light distribution across different the LED groups may not be uniform.

The present system and method utilizes a valley-fill circuit in an AC lighting system. A valley-fill circuit is a type of passive power storage circuit. An AC voltage is applied is rectified to produce a DC voltage, for example using a bridge rectifier, the rectified line voltage is applied across the valley-fill circuit. A charging element of the valley-fill circuit (e.g., capacitor) is charged until it is charged up to approximately half of the peak line voltage. When the line voltage falls below the peak line voltage, into a “valley” phase, the voltage output across the valley-fill circuit begins to fall toward half of the peak line voltage. The charging element begins to discharge into the load at the voltage output.

FIG. 2 illustrates a prior art AC direct step lighting system including a valley fill circuit. The AC direct step lighting system 200 includes an LED driver 230 and is powered by the AC power source 210. The valley fill circuit 240 is disposed between the AC power source 210 and the LED load 220. The LED load 220 is driven by the LED driver 230 in a similar manner described with reference to FIG. 1. The valley fill circuit 240 includes an energy storage element (e.g., a capacitor) and a couple of diodes. The physical layout and the actual implementation of the elements contained in the valley fill circuit 240 are well known in the art, thus the representation of the valley fill circuit 240 in FIG. 2 by a container including a capacitor and two diodes should not be construed as limiting. The diodes utilize energy stored in the energy storage element to drive the LED load 220 when the input voltage from the AC power source 210 is not high enough to drive the LED load 220. The AC direct step lighting system 200 charges and discharges the energy storage element of the valley fill circuit 240 and drives the LED load 220 when necessary. Resultantly, the valley fill circuit 240 changes the current load on AC power source 210 that may impact the power factor and/or total harmonic distortion (THD) that is distortion of the relationship between the AC line power 210 and the LED current draw.

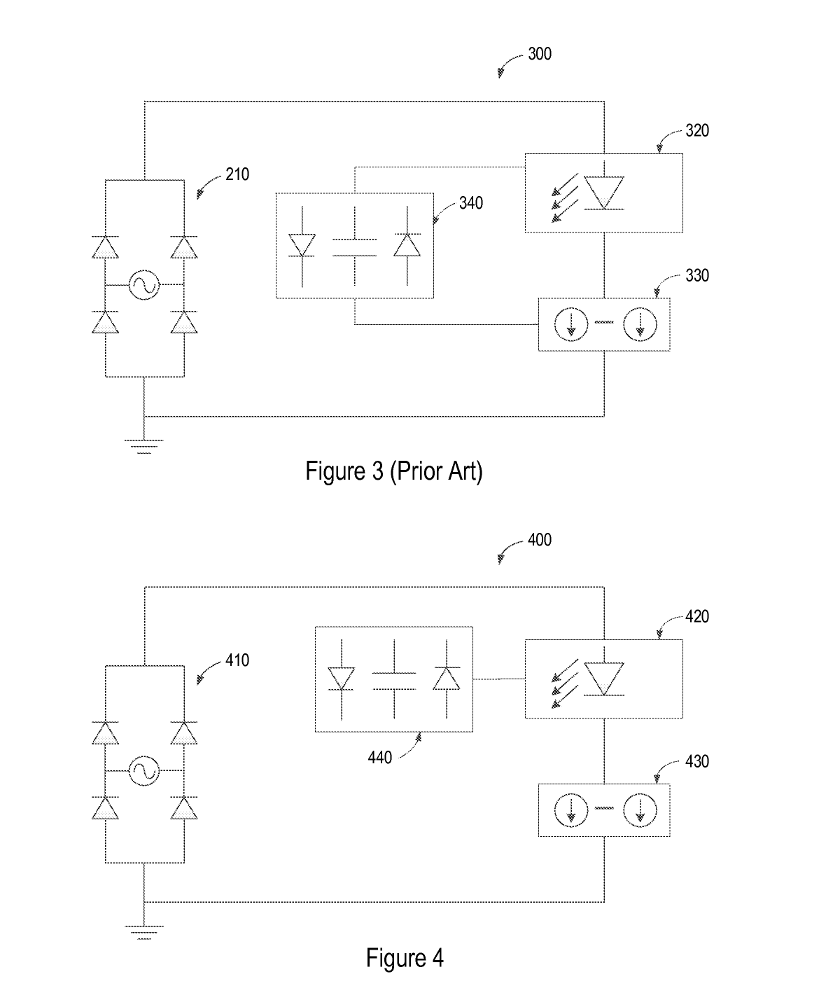

FIG. 3 illustrates another prior art AC direct step lighting system including a valley fill circuit. The AC direct step lighting system 300 includes an LED driver 330 and is powered by the AC power source 310. The valley fill circuit 340 includes an energy storage element (e.g., a capacitor) that is controlled by a charging/discharging driver. The valley fill circuit 340 is disposed between the LED load 320 and the LED driver 330. Unlike, the AC direct step lighting system 300 of FIG. 3, the energy storage element of the valley fill circuit 340 is not directly shown to the AC power source 310, therefore the AC direct step lighting system 300 achieves a higher power factor and THD via the controlled energy storage element. However, the AC direct step lighting system 300 neither guarantees a valley fill action for each LED group nor achieves a light balance across LED groups. In addition, the valley fill circuit 340 requires a control by the LED driver 330 and changes the energy flow between the LED load 320 and the LED driver 330.

FIG. 4 illustrates an exemplary AC direct step lighting system including a valley fill circuit, according to one embodiment. The AC direct step lighting system 400 includes an LED driver 430 and is powered by the AC power source 410. The valley fill circuit 440 is directly connected to the LED load 420. The valley fill circuit 440 does not require a control from the LED driver 430 and locally provides electrical power to the LED load 420. Since the valley fill circuit 440 is not visible to the AC power source 410, it does not affect the load in the AC power line and has a minimal effect on the power factor and THD.

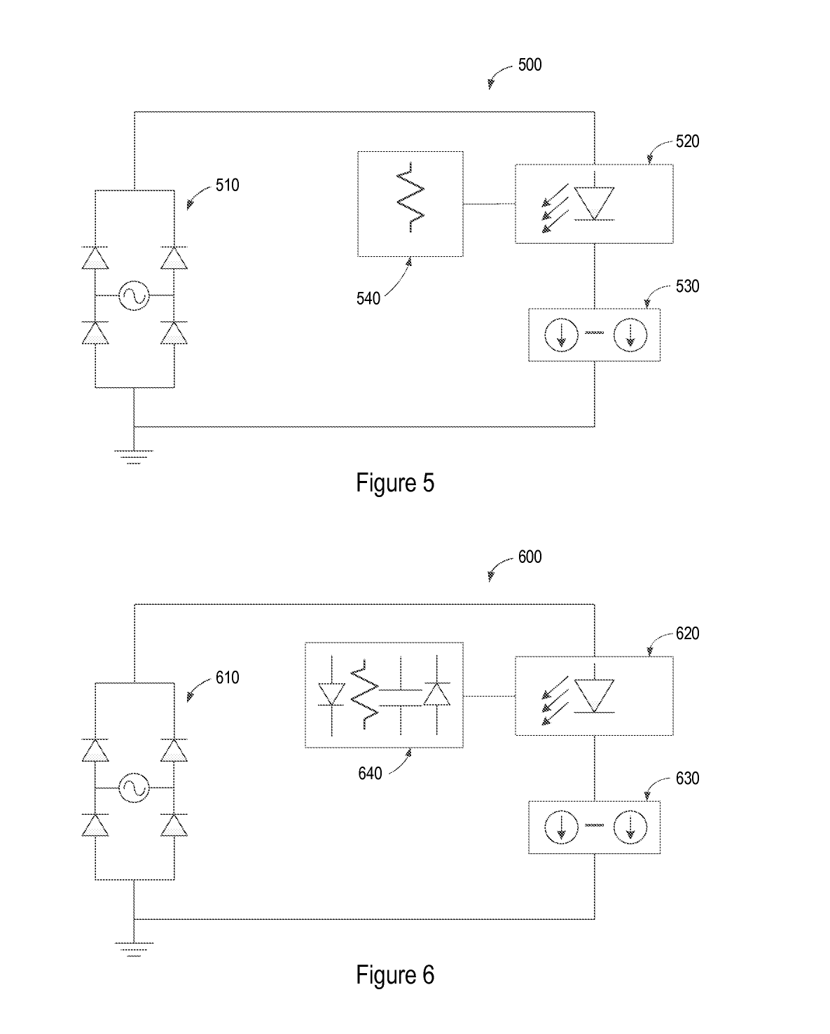

FIG. 5 illustrates an exemplary AC direct step lighting system including a light balancer circuit, according to one embodiment. The AC direct step lighting system 500 includes an LED driver 530 and is powered by the AC power source 510. The light balancer 540 (e.g., a resistor) is directly coupled to the LED load 520. The light balancer 540 in parallel with the target LED group 520 reduces the LED current, and resultantly reduces the brightness of target LED group and matches the brightness of target LED group with other LED groups in the LED load 520.

FIG. 6 illustrates an exemplary AC direct step lighting system including a valley fill circuit and a light balancer circuit, according to one embodiment. The AC direct step lighting system 600 includes an LED driver 630 and is powered by the AC power source 610. A circuit 640 that includes both a valley fill circuit and a load balancer is connected to the LED load 620 including a plurality of LED groups. The valley fill circuit stores and provides continuous energy to a target LED group, and the light balancer reduces the target LED group's current level to match the brightness of target LED group with other LED groups contained in the LED load 620. The light balancer circuit also helps discharging energy stored in the valley fill circuit 640 when the system is disconnected from the AC power source 610 or the AC power source 610 does not have a voltage high enough to drive the LED load 620.

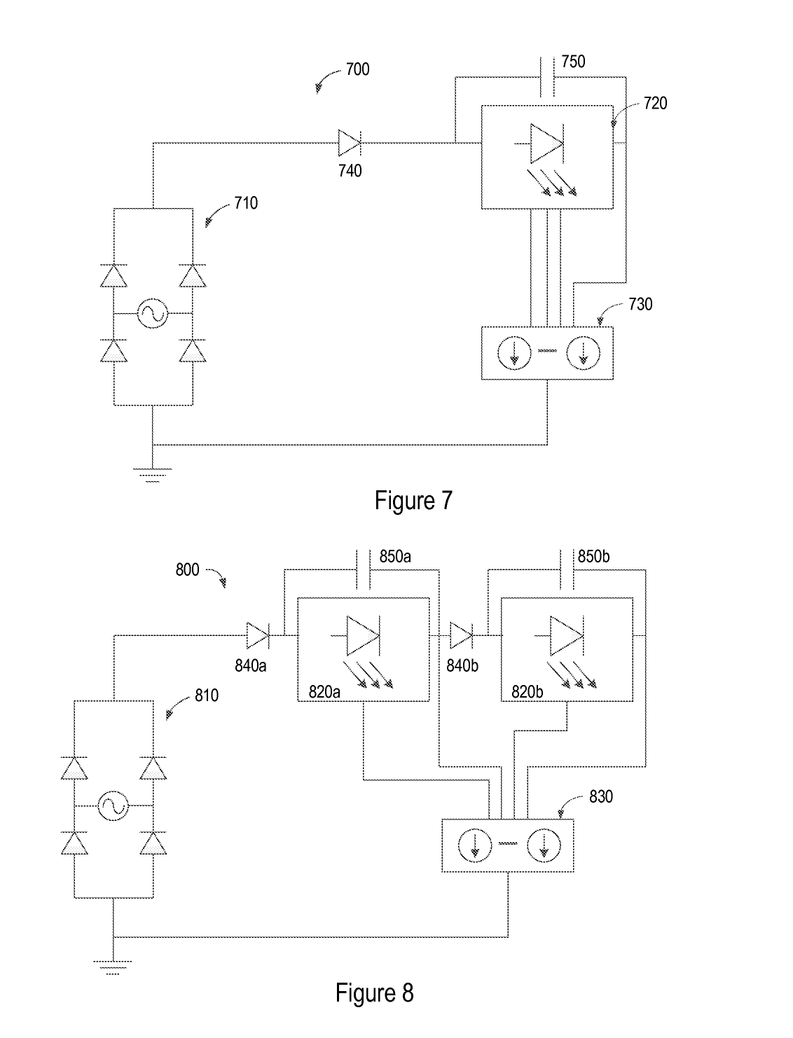

FIG. 7 illustrates an exemplary AC direct step lighting system including a valley fill circuit, according to another embodiment. The AC direct step lighting system 700 includes an LED driver 730 and is powered by the AC power source 710. The valley fill circuit has a diode 740 disposed between the rectified AC voltage source 710 and a first LED group and a capacitor 750 across the LED load 720. In this example, the LED driver 730 has 4 current sinks, therefore the LED driver 730 can drive up to four LED groups. Depending on the number of current sinks in the LED driver, different number and combination of LED groups may be driven by the LED driver 730. The diode 740 prevents the stored energy from flowing in the opposite direction and provides electrical power from the AC voltage source 710 to the LED groups contained in the LED load 720. The capacitor 750 provides energy to the LED group 720 when the system is disconnected from the AC power source 710 or the voltage level of the AC power source 710 is not high or stable enough to drive the LED load 720.

FIG. 8 illustrates an exemplary AC direct step lighting system including a valley fill circuit for each target LED group, according to one embodiment. The AC direct step lighting system 800 includes an LED driver 830 and the LED groups 820a and 820b powered by the LED driver 830. Each of the LED group (820a and 820b) is coupled to a corresponding valley fill circuit that includes a diode (840a and 840b) and a capacitor (850a and 850b). The LED groups 820a and 820b is a representation of any number of LED groups grouped together, in this example, two LED groups. The capacitors 850a and 850b are used to store and drive the coupled target LED groups 820a and 820b, and the diodes 840a and 840b prevent the stored energy from flowing in the opposite direction and provides the energy for corresponding target LED group. The LED groups 820a and 820b are connected in series, thus are powered in sequence.

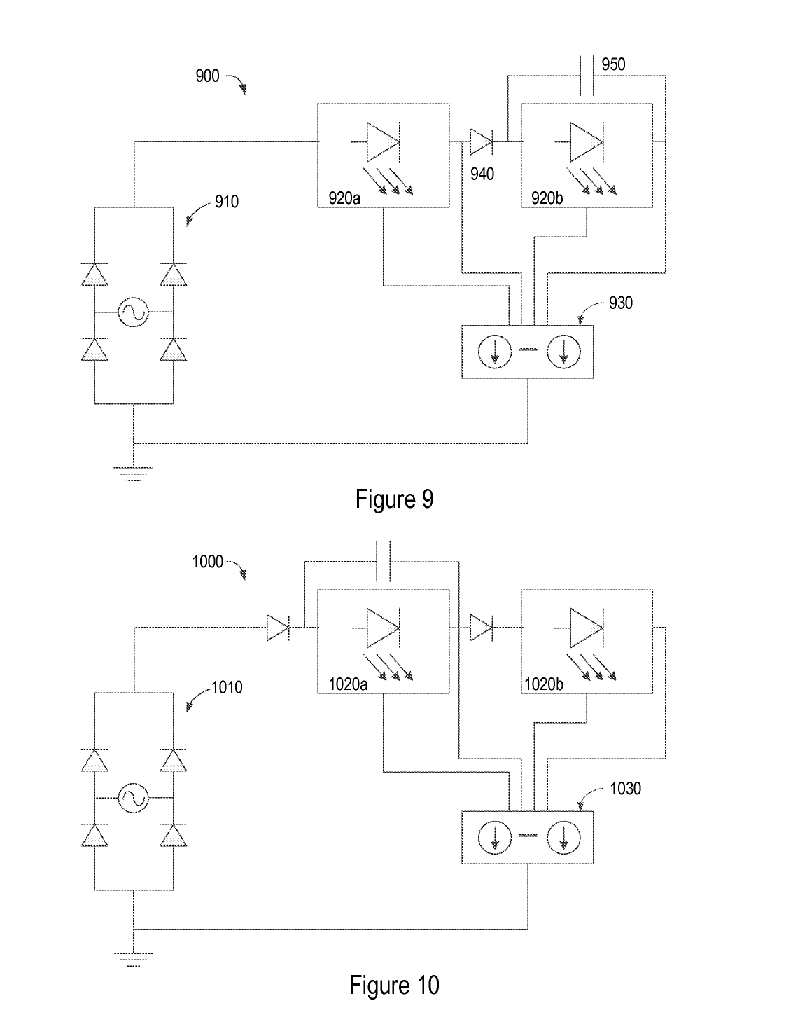

FIG. 9 illustrates an exemplary AC direct step lighting system including a valley fill circuit for each target LED group, according to another embodiment. The AC direct step lighting system 900 includes an LED driver 930 and the LED groups 920a and 920b powered by the LED driver 930. In this embodiment, the valley fill circuit is used on a downstream portion of the LED load, i.e., the LED group 920b. The AC direct step lighting system 900 reduces light fluctuation on the target LED group and minimizes voltage fluctuation shown on current sink in the LED driver 930 that drives the target LED group.

FIG. 10 illustrates an exemplary AC direct step lighting system including a valley fill circuit for each target LED group, according to another embodiment. The valley fill circuit is used on the upstream portion of the LED load. In comparison to the AC direct step lighting system 800 wherein each LED group has both a valley fill circuit and a load balancer circuit, the AC direct step lighting system 900 and 1000 may target a specific LED group and lower ripple in the target LED group using less elements.

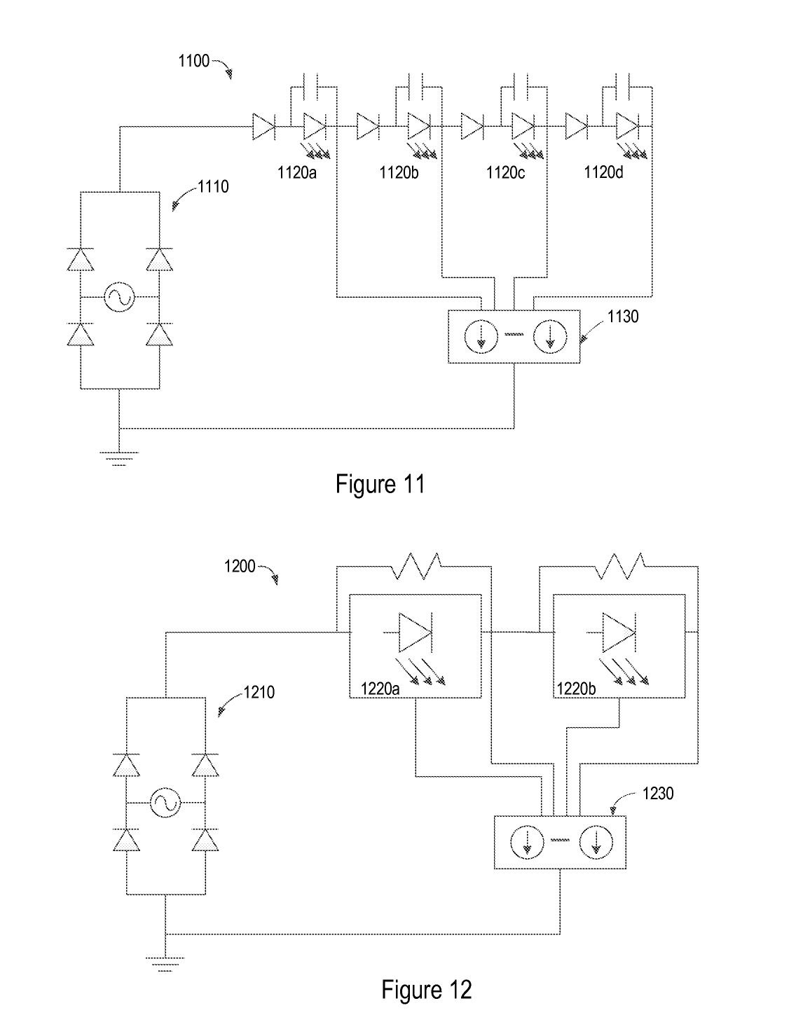

FIG. 11 illustrates an exemplary AC direct step lighting system including a valley fill circuit for each LED group, according to another embodiment. The AC lighting system 1100 has four valley fill circuits. Each of the valley fill circuits is used across the corresponding target LED group 1120. The valley fill circuit has a diode disposed on the upstream of the corresponding LED group and a capacitor across the corresponding LED group. The diode prevents the stored energy from flowing in the opposite direction and provides energy from the AC voltage source 1110 to the target LED group. The AC direct step lighting system 1100 provides flicker free operation across the LED groups. The sizes (or values) of the energy blocking element (e.g., diode) and the energy storage element (e.g., capacitor) in each valley fill circuit may be determined to provide a desired lighting operation. Flicking may vary depending on various factors, for example, the flicker spec, the LED power supply and the LED power consumption. By changing these values of the diode and capacitor for each target LED group, the AC lighting system 1100 can achieve a desired flicker spec without changing the design of the LED driver 1130.

FIG. 12 illustrates an exemplary AC direct step lighting system including a plurality of load balancer circuits for each LED group, according to one embodiment. The AC lighting system 1200 has two LED groups 1220a and 1220b. Each of the LED groups 1220a and 1220b is coupled with a corresponding load balancer circuit. A resistor of the load balancer circuit is used as a bleeder. However, it is appreciated that any current flowing circuit can be used, for example, a metal-oxide-semiconductor field-effect transistor (MOSFET). The resistor is disposed in parallel with the target LED group to separately draw current from the target LED group and reduce current flowing into the target LED group.

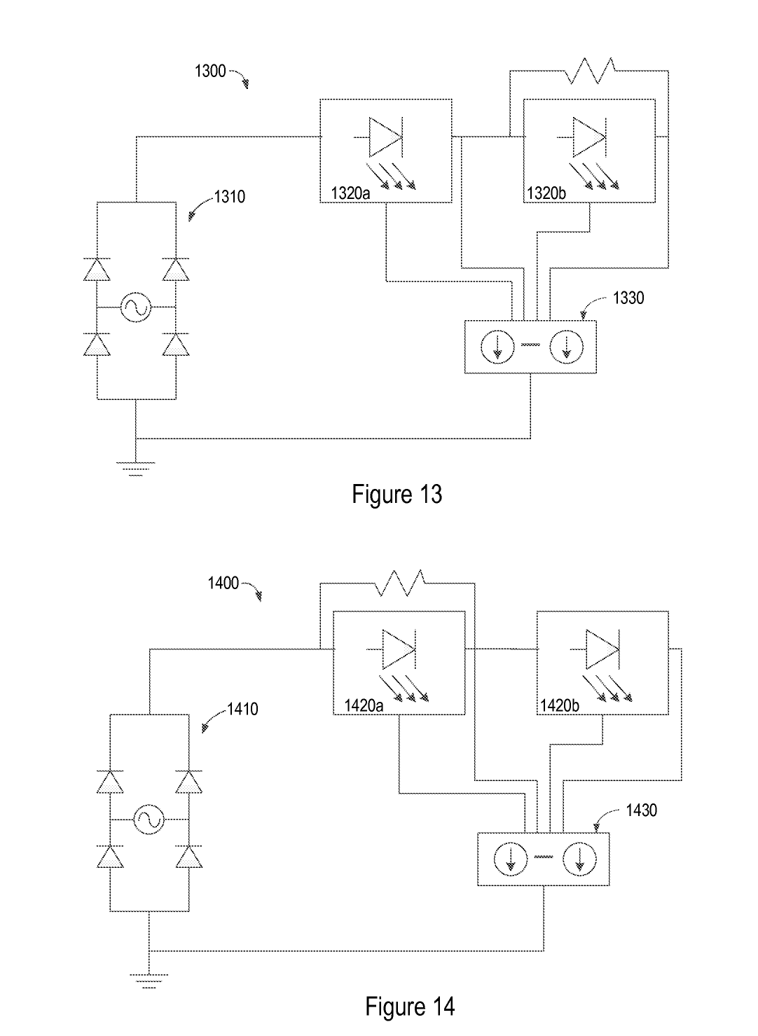

FIG. 13 illustrates an exemplary AC direct step lighting system including a load balancer circuit for a downstream LED group, according to another embodiment. Resistor is used as a bleeder for a downstream LED group. The AC lighting system 1300 can be used to lower the current in the downstream LED group 1320b. After testing luminous flux of the AC lighting system 1300, luminous flux for each LED group can be adjusted individually to achieve a desired light uniformity.

FIG. 14 illustrates an exemplary AC direct step lighting system including a load balancer circuit for an upstream LED group, according to another embodiment. Resistor is used as a bleeder for an upstream LED group. The AC lighting system 1400 can be used to lower the current in the upstream LED group 1420a to match with the light density (or luminous flux) in the downstream LED groups 1420a to achieve uniform brightness across the LED groups.

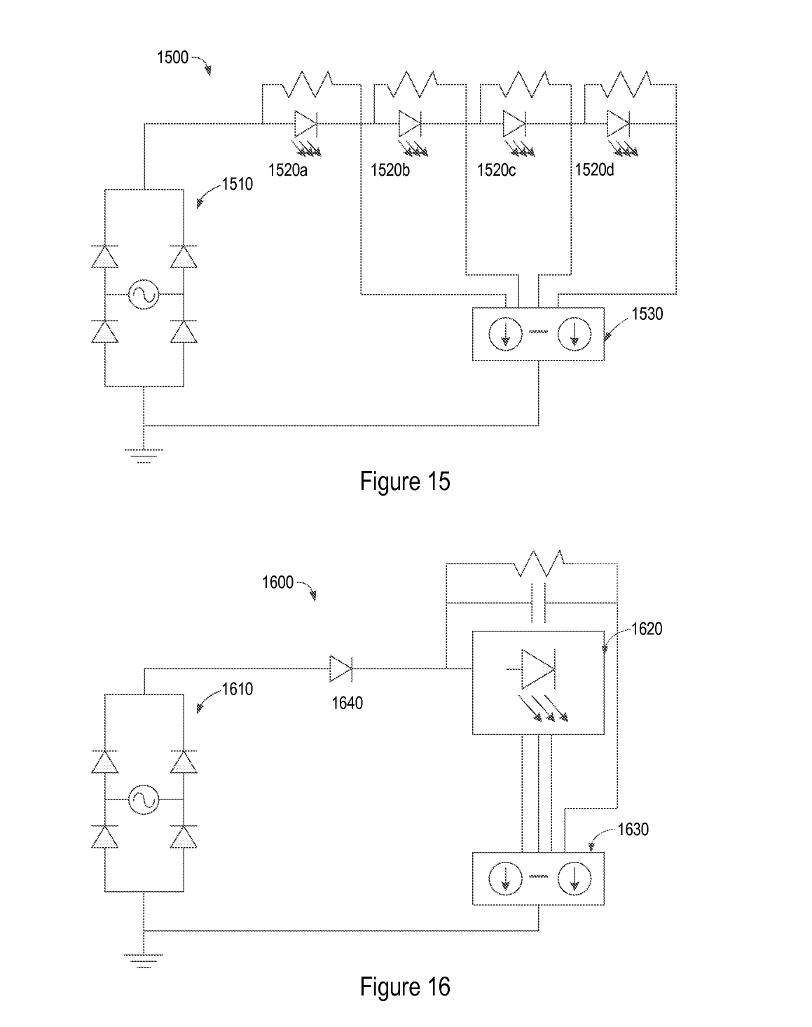

FIG. 15 illustrates an exemplary AC direct step lighting system including a plurality of load balancer circuits for each LED group, according to another embodiment. Resistor is used as a bleeder for each LED group. Each bleeder can be sized differently to change the each LED group's current level separately to match each LED group's the light density (or luminous flux) to achieve uniform brightness across the LED groups.

FIG. 16 illustrates an exemplary AC direct step lighting system including a valley fill circuit and a light balancer circuit, according to one embodiment. The AC lighting system 1600 has a single valley fill circuit including the diode 1640 and a single load balancer circuit that are connected to the terminal ends of the LED load 1620. The LED load 1620 may contain any number of LED groups in it, and the valley fill circuit and the light balancer circuit controls the current flow across the LED groups.

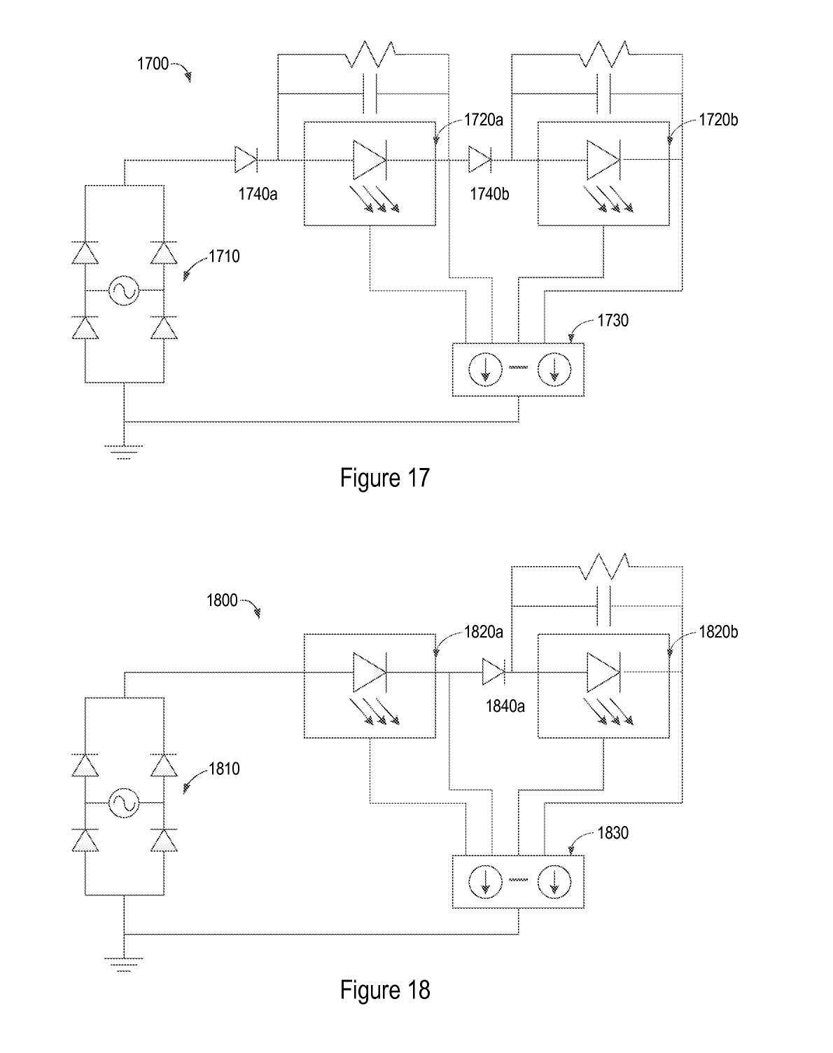

FIGS. 17-23 illustrate an exemplary AC direct step lighting system including various combinations of a valley fill circuit and a light balancer circuit, according to some embodiments. The valley fill circuit and a load balancer circuit are applied to different LED groups separately.

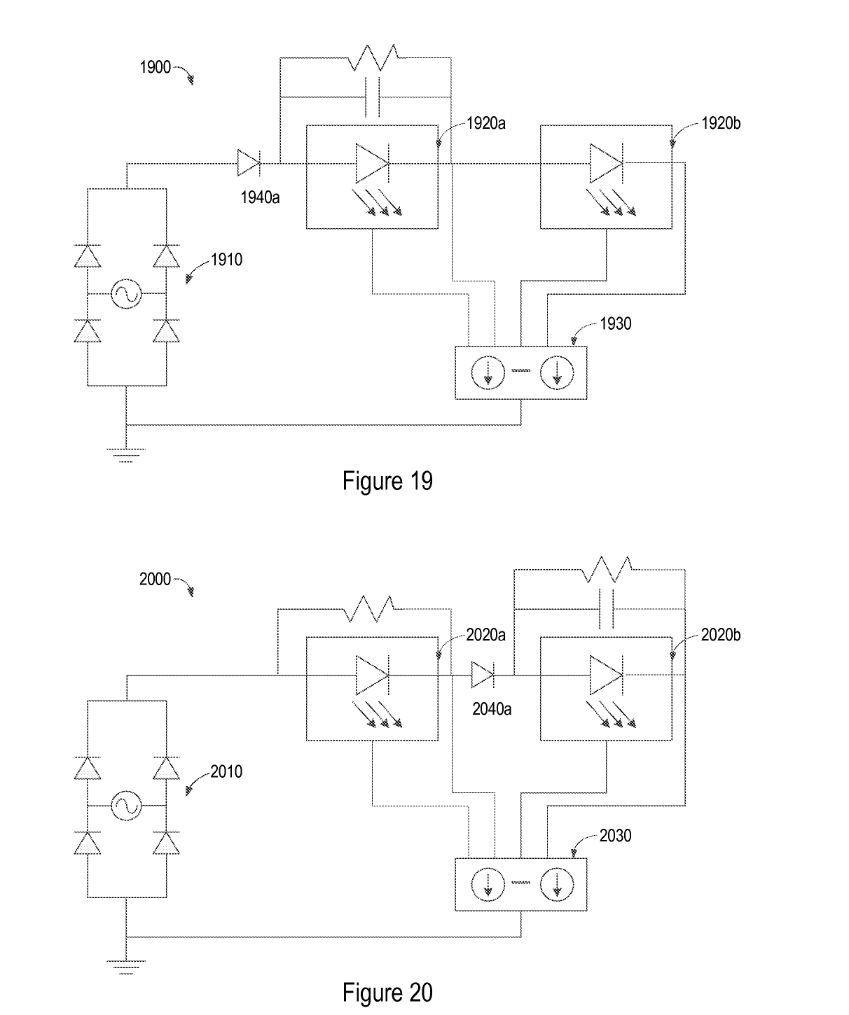

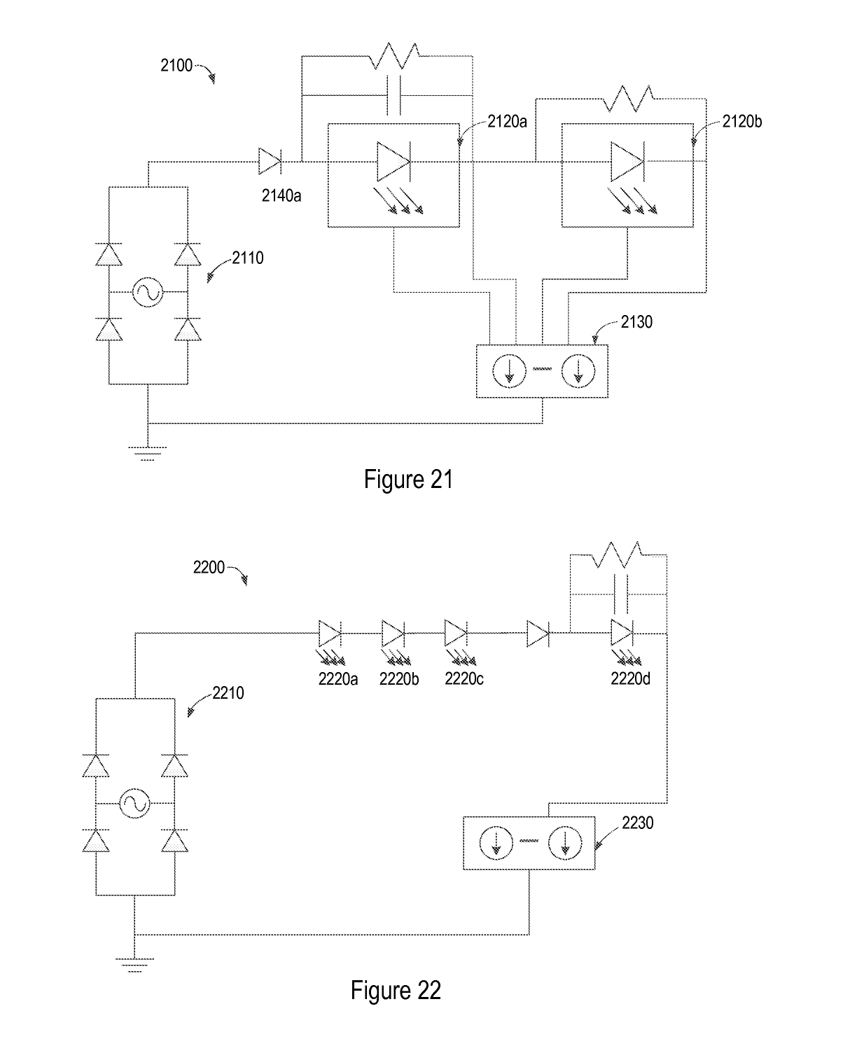

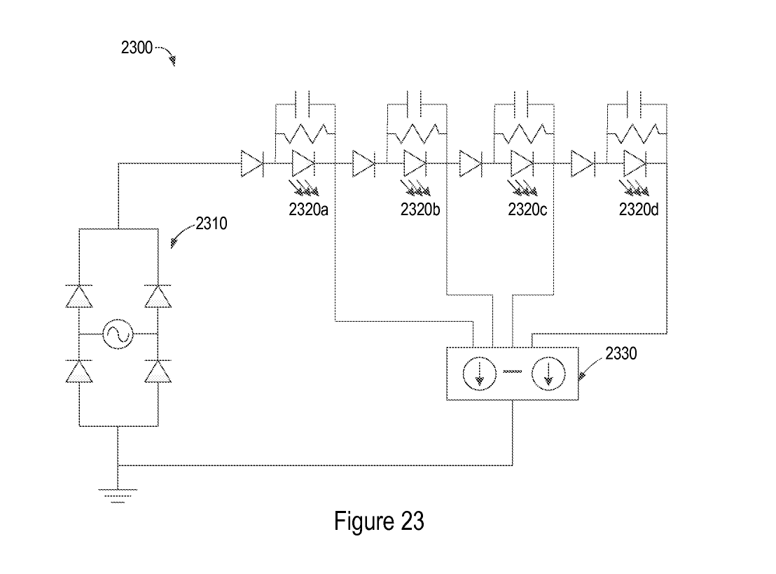

The AC lighting system 1700 of FIG. 17 has two valley fill circuits and light balancer circuits for each of the two LED groups 1720a and 1720b. The LED groups 1720a and 1720b may contain several LED groups in them, for example, two LED groups. The AC lighting system 1800 of FIG. 18 has a valley fill circuit and a light balancer circuit for the downstream LED groups 1820a. The AC lighting system 1900 of FIG. 19 has a valley fill circuit and a light balancer circuit for the upstream LED groups 1920a. The AC lighting system 2000 of FIG. 20 has a load balancer circuit for the upstream LED group 2020a and a combination of a valley fill circuit and a light balancer circuit for the downstream LED group 2020b. The AC lighting system 2100 of FIG. 21 has a load balancer circuit for the downstream LED group 2120b and a combination of a valley fill circuit and a light balancer circuit for the upstream LED group 2120a. The AC lighting system 2200 of FIG. 22 has a load balancer circuit and a valley fill circuit only for the downstream LED group 2220d. The AC lighting system 2300 of FIG. 23 has a combination of a valley fill circuit a load balancer circuit for each of the LED groups 2320a-2320d.

The present disclosure describes an AC direct drive lighting system including a valley fill circuit and a light balancer circuit to provide uniform light distribution and minimize flickering. According to some embodiments, the valley fill circuit includes an energy storage element (e.g., capacitor) and an energy blocking element (e.g., diode). The valley fill circuit may be coupled to an individual LED group of an LED load. According to one embodiment, the light balancer includes a bleeder that is applied to an individual LED group. The valley fill circuit and the light balancer circuit may be combined together and used in different LED group separately. The valley fill circuit and the light balancer circuit do not need a dedicated control and are self-controlled by selecting capacitor and resistance values for the components used in each circuit.

The above exemplary embodiments illustrate various embodiments of implementing an AC lighting system including a valley fill circuit and/or a light balancer circuit for providing uniform light distribution. Various modifications and departures from the disclosed example embodiments will occur to those having ordinary skill in the art. The subject matter that is intended to be within the scope of the invention is set forth in the following claims.

We claim:

1. An alternating current (AC) lighting system comprising:
an AC power source;
a plurality of LED groups; and
an AC driver comprising a current sink connected between the AC power source and the plurality of LED groups;
at least one of a valley fill circuit and a load balancer circuit coupled to a target LED group of the plurality of LED groups,
wherein the valley fill circuit charges supplies electrical power to a target LED group and the load balancer circuit reduces the current flowing through the target LED group.

2. The AC lighting system of claim 1, wherein the load balancer circuit reduces brightness of the target LED group to match brightness of a second target LED group of the AC lighting system.

3. The AC lighting system of claim 1, wherein the plurality of LED groups includes a first LED group and a second LED group.

4. The AC lighting system of claim 3, wherein the first LED group is coupled to the valley fill circuit and the load balancer circuit.

5. The AC lighting system of claim 3, wherein the first LED group is an upstream LED group of the plurality of LED groups.

6. The AC lighting system of claim 3, wherein the first LED group is a downstream LED group of the plurality of LED groups.

7. The AC lighting system of claim 3, wherein the second LED group is coupled to a second valley fill circuit and a second load balancer circuit.

8. The AC lighting system of claim 3, wherein the first LED group is coupled to the valley fill circuit, and wherein the second LED group is coupled to a second valley fill circuit and a second load balancer circuit.

9. The AC lighting system of claim 3, wherein the first LED group is coupled to the lad balancer circuit, and wherein the second LED group is coupled to a second valley fill circuit and a second load balancer circuit.

10. The AC lighting system of claim 1, wherein the plurality of LED groups includes four LED groups connected in series.

11. The AC lighting system of claim 10, wherein the four LED groups are coupled to a respective valley fill circuit and a respective load balancer circuit.

12. The AC lighting system of claim 10, wherein the four LED groups are coupled to a respective valley fill circuit.

13. The AC lighting system of claim 10, wherein the four LED groups are coupled to a respective load balancer circuit.

14. The AC lighting system of claim 10, wherein a downstream LED group is coupled to the valley fill circuit and the load balancer circuit.

15. A method for driving a plurality of LED groups comprising:
providing an LED driver that is configured to control an LED current flowing through a plurality of LED groups using a plurality of current sinks;
coupling at least one of a valley fill circuit and a load balancer circuit coupled to a target LED group of the plurality of LED groups,
wherein the valley fill circuit charges supplies electrical power to a target LED group and the load balancer circuit reduces the current flowing through the target LED group.

16. The method of claim 15, wherein the load balancer circuit reduces brightness of the target LED group to match brightness of a second target LED group of the AC lighting system.

17. The method of claim 15, wherein the plurality of LED groups includes a first LED group and a second LED group.

18. The method of claim 17, further comprising coupling the first LED group to the valley fill circuit and the load balancer circuit.

19. The method of claim 17, further comprising coupling the first LED group to one of the valley fill circuit and the load balancer circuit, and coupling the second LED group to one of a second valley fill circuit and a second load balancer circuit.

20. The method of claim 15, wherein the plurality of LED groups includes four LED groups connected in series.

21. The method of claim 20, further comprising coupling the four LED groups are coupled to a respective valley fill circuit and a respective load balancer circuit.

22. The method of claim 20, further comprising coupling a downstream LED group to one or more of the valley fill circuit and the load balancer circuit.
